(19) United States
(12) Patent Application Publication
(10) Pub. No.: US 2013/0293139 A1
(43) Pub. Date: Nov. 7, 2013

(54) Dimmable Driver and Interface

(71) Applicants: Laurence P. Sadwick, Salt Lake City, UT (US); Neil J. Barabas, Chatsworth, CA (US); William B. Sackett, Salt Lake City, UT (US); Skylar Stoddard, Salt Lake City, UT (US)

(72) Inventors: Laurence P. Sadwick, Salt Lake City, UT (US); Neil J. Barabas, Chatsworth, CA (US); William B. Sackett, Salt Lake City, UT (US); Skylar Stoddard, Salt Lake City, UT (US)

(21) Appl. No.: 13/931,794

(22) Filed: Jun. 28, 2013

Related U.S. Application Data
(63) Continuation-in-part of application No. 13/404,514, filed on Feb. 24, 2012, now Pat. No. 8,502,477.
(60) Provisional application No. 61/665,876, filed on Jun. 28, 2012.

(51) Int. Cl. H05B 37/02

(52) U.S. Cl. CPC H05B 37/02
USPC 315/224

(57) ABSTRACT

A dimmable driver is disclosed with multiple channels, universal dimming over multiple input voltage ranges and a web-based user interface for dimming settings.

### BACKGROUND

Electricity is generated and distributed in alternating current (AC) form, wherein the voltage varies sinusoidally between a positive and a negative value. However, many electrical devices require a direct current (DC) supply of electricity having a constant voltage level, or at least a supply that remains positive even if the level is allowed to vary to some extent. For example, light emitting diodes (LEDs) and similar devices such as organic light emitting diodes (OLEDs) are being increasingly considered for use as light sources in residential, commercial and municipal applications. However, in general, unlike incandescent light sources, LEDs and OLEDs cannot be powered directly from an AC power supply unless, for example, the LEDs are configured in some back to back formation.

### SUMMARY

Various embodiments of a dimmable power supply are disclosed herein. For example, some embodiments provide a dimmable power supply including an output driver, a variable pulse generator and a load current detector. The output driver has a power input, a control input and a load path. In some embodiments, an interface for selecting color and intensity is provided. In some embodiments, universal dimming is provided.

This summary provides only a general outline of some particular embodiments. Many other objects, features, advantages and other embodiments will become more fully apparent from the following detailed description, the appended claims and the accompanying drawings.

### BRIEF DESCRIPTION OF THE DRAWINGS

A further understanding of the various embodiments may be realized by reference to the figures which are described in remaining portions of the specification. In the figures, like reference numerals may be used throughout several drawings to refer to similar components.

FIG. 1 depicts a block diagram of a dimmable power supply in accordance with some embodiments.

FIG. 2 depicts a block diagram of a dimmable power supply with internal dimming.

FIG. 3 depicts a block diagram of a dimmable power supply with current overload and thermal protection.

FIG. 4 depicts a block diagram of a dimmable power supply with internal dimming and current overload and thermal protection.

FIG. 5 depicts a block diagram of a dimmable power supply with a DC input.

FIG. 6 depicts a block diagram of a dimmable power supply in accordance with some embodiments.

FIG. 7 depicts a schematic of a dimmable power supply in accordance with some embodiments.

FIG. 8 depicts a depicts a schematic of a power supply with a transformer for isolation in flyback mode in accordance with some embodiments.

FIG. 9 depicts a depicts a schematic of a dimmable power supply with a transformer for isolation in flyback mode in accordance with some embodiments.

FIG. 10 depicts a depicts a schematic of a dimmable power supply with a transformer for isolation in accordance with some embodiments.

FIG. 11 depicts a flow chart of a method of dimmably supplying a load current in accordance with some embodiments.

FIG. 12 depicts a universal dimmer in accordance with some embodiments.

FIG. 13 depicts an interface for selecting a dimming level in accordance with some embodiments.

FIG. 14 depicts an interface for selecting a multi-channel or multi-color dimming level in accordance with some embodiments.

FIG. 15 depicts a block diagram of a system for controlling a multi-channel dimming driver in accordance with some embodiments.

### DESCRIPTION

The drawings and description, in general, disclose various embodiments of a dimmable power supply for loads such as an LED or array of LEDs, motors, fans or other dimmable loads. The dimmable power supply may use either an AC or DC input, with a varying or constant voltage level. The current through the load from the dimmable power supply may be adjusted using conventional or other types of dimmers in the power supply line upstream from the dimmable power supply. Thus, the term “dimmable” is used herein to indicate that input voltage of the dimmable power supply may be varied to dim a load or otherwise reduce the load current, without the control system in the dimmable power supply opposing the resulting change to the load current and keeping the load current constant. Various embodiments of the dimmable power supply may, in addition to being externally dimmable, be internally dimmable by including dimming elements within the dimmable power supply. In these embodiments, the load current may be adjusted by controlling the input voltage of the dimmable power supply using an external dimmer and by controlling the internal dimming elements within the dimmable power supply. Internal dimming can be implemented and accomplished by, for example, among others, on/off using pulse width modulation (PWM) at appropriate frequencies, 0 to 10 V, the use of resistors including variable resistor(s), encoders, analog and/or digital resistors, or any other type of analog, digital or a mixture of analog and digital.

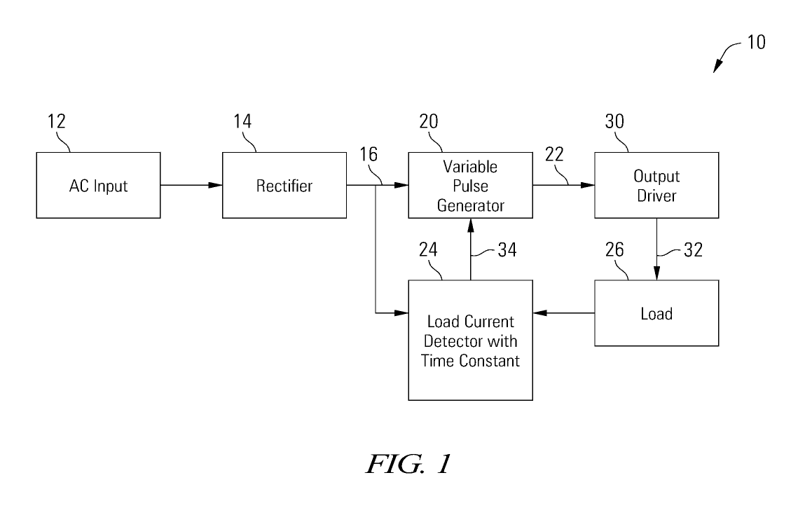

Referring now to FIG. 1, a block diagram of an embodiment of a dimmable power supply 10 is shown. In this embodiment, the dimmable power supply 10 is powered by an AC input 12, for example by a 50 or 60 Hz sinusoidal waveform of 120 V or 240 V RMS such as that supplied to residences by municipal electric power companies. It is important to note, however, that the dimmable power supply 10 is not limited to any particular power input. Furthermore, the voltage applied to the AC input 12 may be externally controlled, such as in an external dimmer (not shown) that reduces the voltage. The AC input 12 is connected to a rectifier 14 to rectify and invert any negative voltage component from the AC input 12. Although the rectifier 14 may filter and smooth the power output 16 if desired to produce a DC signal, this is not necessary and the power output 16 may be a series of rectified half sinusoidal waves at a frequency double that at the AC input 12, for example 120 Hz. A variable pulse generator 20 is powered by the power output 16 from the AC input 12 and rectifier 14 to generate a train of pulses at an output 22. The variable pulse generator 20 may comprise any device or circuit now known or that may be developed in the future to generate a train of pulses of any desired shape. For example, the variable pulse generator 20 may comprise devices such as comparators, amplifiers, oscillators, counters, frequency generators, etc.

The pulse width of the train of pulses is controlled by a load current detector 24 with a time constant based on a current level through a load 26. Various implementations of pulse width control including pulse width modulation (PWM) by frequency, analog and/or digital control may be used to realize the pulse width control. Other features such as soft start, delayed start, instant on operation, etc. may also be included if deemed desirable, needed, and/or useful. An output driver 30 produces a current 32 through the load 26, with the current level adjusted by the pulse width at the output 22 of the variable pulse generator 20. The current 32 through the load 26 is monitored by the load current detector 24. The current monitoring performed by the load current detector 24 is done with a time constant that includes information about voltage changes at the power output 16 of the rectifier 14 slower than or on the order of a waveform cycle at the power output 16, but not faster changes at the power output 16 or voltage changes at the output 22 of the variable pulse generator 20. The control signal 34 from the load current detector 24 to the variable pulse generator 20 thus varies with slower changes in the power output 16 of the rectifier 14, but not with the incoming rectified AC waveform or with changes at the output 22 of the variable pulse generator 20 due to the pulses themselves. In one particular embodiment, the load current detector 24 includes one or more low pass filters to implement the time constant used in the load current detection. The time constant may be established by a number of suitable devices and circuits, and the dimmable power supply 10 is not limited to any particular device or circuit. For example, the time constant may be established using RC circuits arranged in the load current detector 24 to form low pass filters, or with other types of passive or active filtering circuits. The load 26 may be any desired type of load, such as a light emitting diode (LED) or an array of LEDs arranged in any configuration. For example, an array of LEDs may be connected in series or in parallel or in any desired combination of the two. The load 26 may also be an organic light emitting diode (OLED) in any desired quantity and configuration. The load 26 may also be a combination of different devices if desired, and is not limited to the examples set forth herein. Hereinafter, the term LED is used generically to refer to all types of LEDs including OLEDs and is to be interpreted as a non-limiting example of a load.

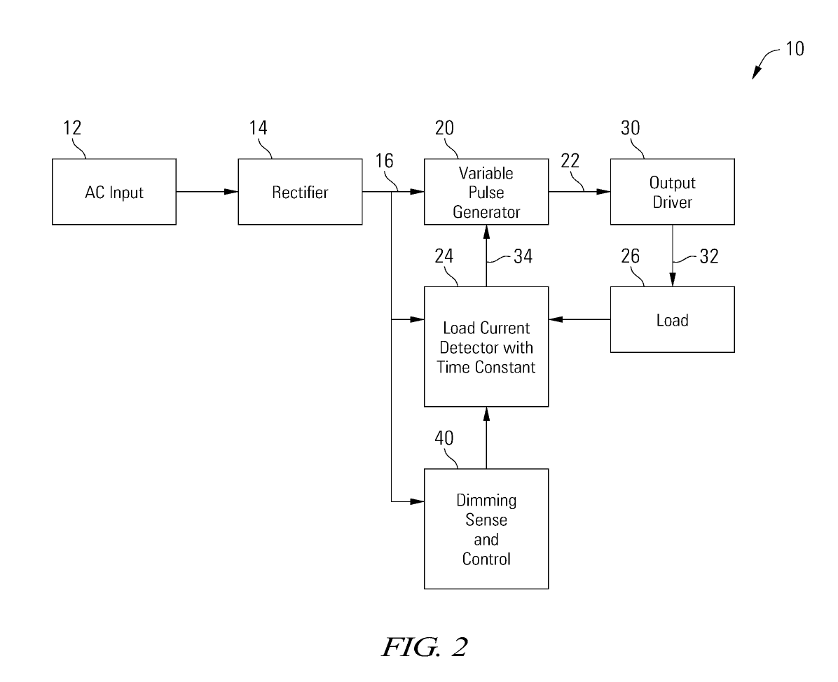

Referring now to FIG. 2, some embodiments of the dimmable power supply 10 may also include an internal dimmer 40 adapted to adjustably reduce the current 32 through the load 26 by narrowing the pulse width at the output 22 of the variable pulse generator 20. This may be accomplished in a number of ways, for example by adjusting a reference voltage or current in the load current detector 24 that is based on the power output 16 from the rectifier 14. The internal dimmer 40 may also adjust the level of a feedback voltage or current from the load 26 to narrow the pulse width and reduce the load current. The internal dimmer can also be based on pulse width modulation (PWM) and related methods, techniques and technologies.

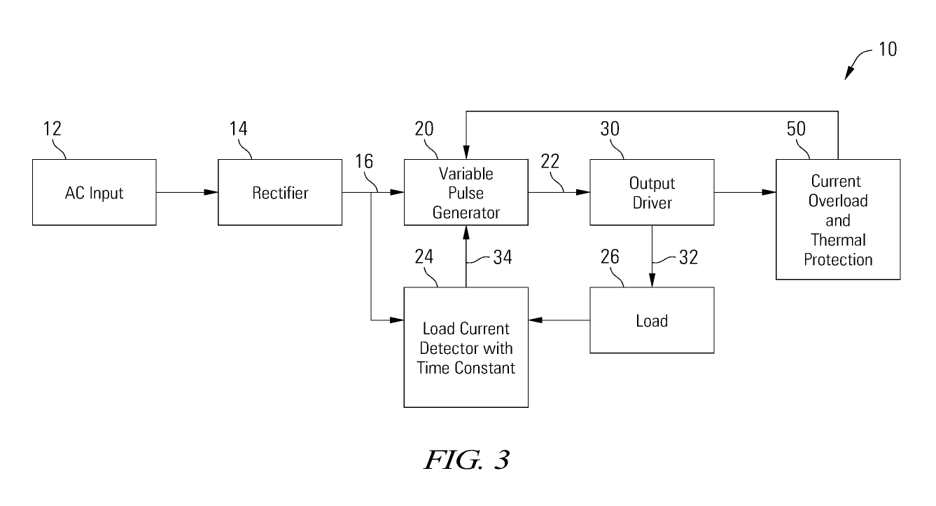

Some embodiments of the dimmable power supply 10 may include current overload protection and/or thermal protection 50, as illustrated in FIG. 3. As an example, the current overload protection 50 measures the current through the dimmable power supply 10 and narrows or turns off the pulses at the output 22 of the variable pulse generator 20 if the current exceeds a threshold value. The current detection for the current overload protection 50 may be adapted as desired to measure instantaneous current, average current, or any other measurement desired and at any desired location in the dimmable power supply 10. Thermal protection 50 may also be included to narrow or turn off the pulses at the output 22 of the variable pulse generator 20 if the temperature in the dimmable power supply 10 becomes excessive, thereby reducing the power through the dimmable power supply 10 and allowing the dimmable power supply 10 to cool. The thermal protection may also be designed and implemented such that at a prescribed temperature, the pulses are turned off which effectively disables the power supply and turns off the output to the load. The temperature sensor can be any type of temperature sensitive element including semiconductors such as diodes, transistors, etc. and/or thermocouples, thermistors, bimetallic elements and switches, etc.

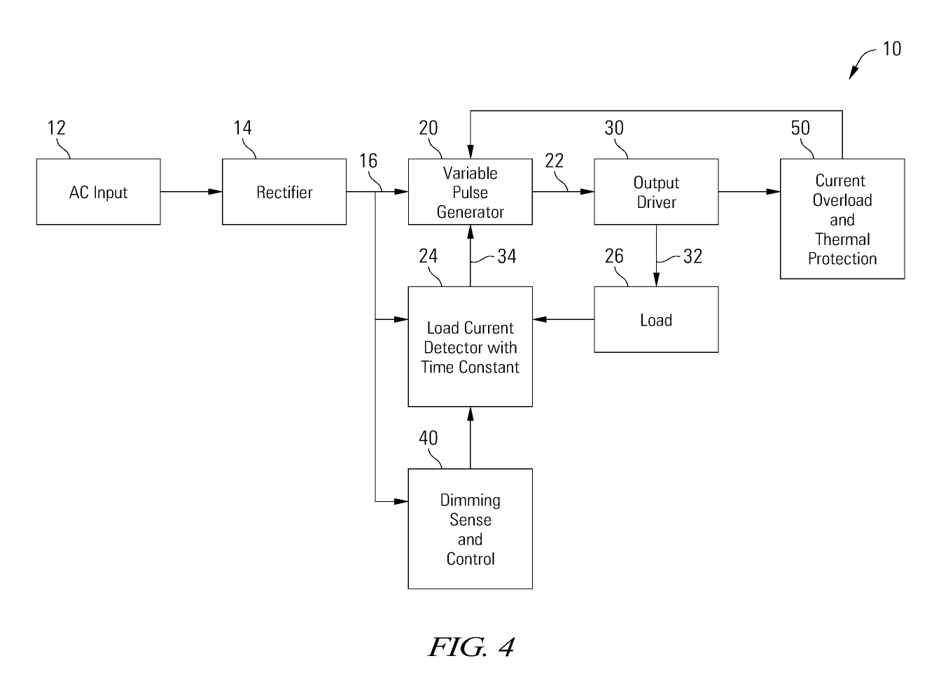

Elements of the various embodiments disclosed herein may be included or omitted as desired. For example, in the block diagram of FIG. 4, a dimmable power supply 10 is disclosed that includes both the internal dimmer 40 and the current overload protection the thermal protection 50.

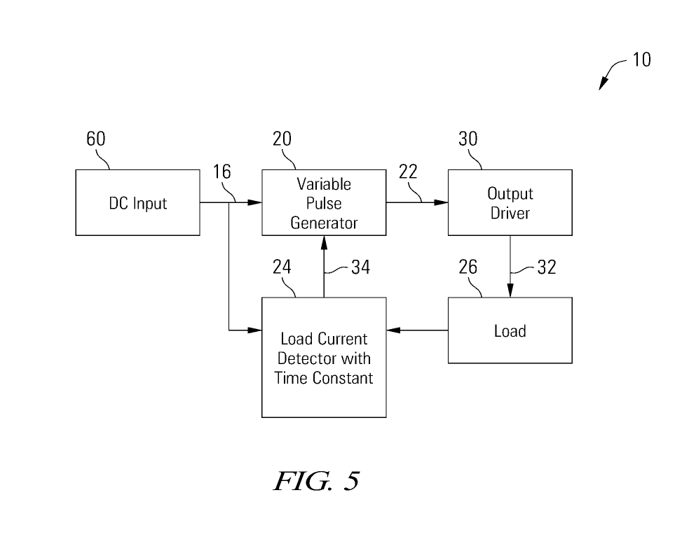

As discussed above, the dimmable power supply 10 may be powered by any suitable power source, such as the AC input 12 and rectifier 14 of FIG. 1, or a DC input 60 as illustrated in FIG. 5. Time constants in the dimmable power supply 10 are adapted to produce pulses in the output 22 of the variable pulse generator 20 having a constant width across the input voltage waveform from a rectified AC input 12, thereby maintaining a good and high power factor, while still being able to compensate for slower changes in the input voltage to provide a constant load current.

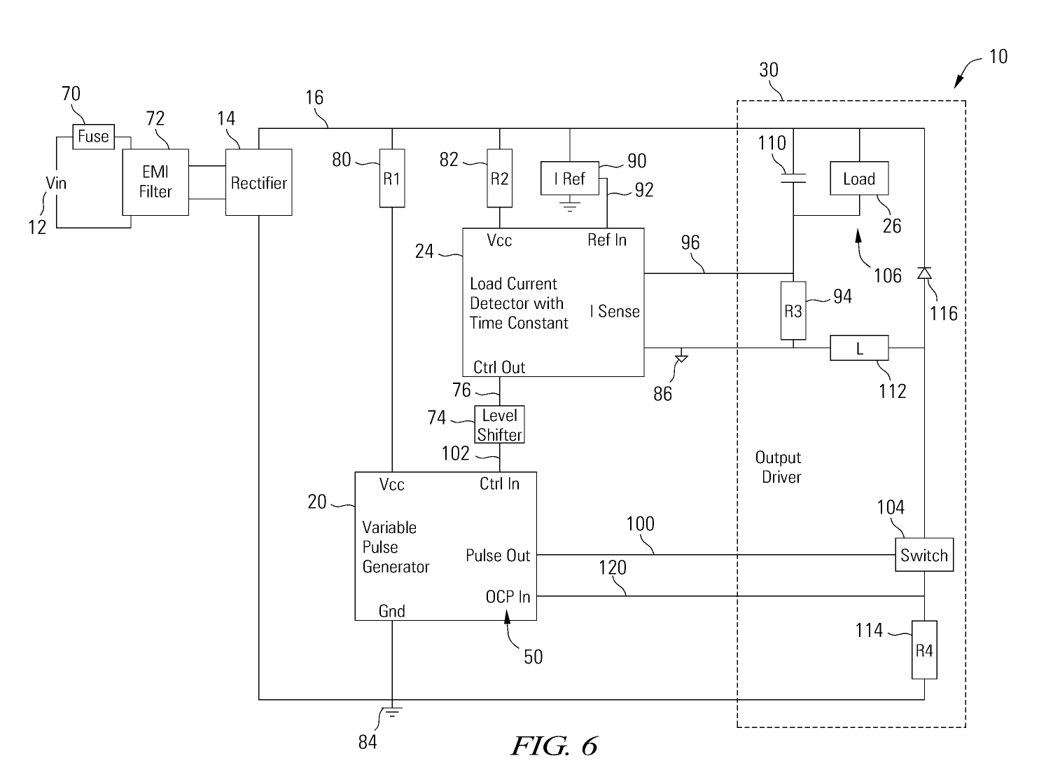

Referring now to FIG. 6, the dimmable power supply 10 will be described in more detail. In the diagram of FIG. 6, the load 26 is shown inside the output driver 30 for convenience in setting forth the connections in the diagram. An AC input 12 is shown, and is connected to the dimmable power supply 10 in this embodiment through a fuse 70 and an electromagnetic interference (EMI) filter 72. The fuse 70 may be any device suitable to protect the dimmable power supply 10 from overvoltage or overcurrent conditions, such as a traditional meltable fuse or other device (e.g., a small low power surface mount resistor), a breaker, etc. The EMI filter 72 may be any device suitable to prevent EMI from passing into or out of the dimmable power supply 10, such as a coil, inductor, capacitor and/or any combination of these, or, also in general, a filter, etc. The AC input 12 is rectified in a rectifier 14 as discussed above. In other embodiments, the dimmable power supply 10 may use a DC input as discussed above. In this embodiment, the dimmable power supply 10 may generally be divided into a high side portion including the load current detector 24 and a low side portion including the variable pulse generator 20, with the output driver 30 spanning or including the high and low side. In this case, a level shifter 74 may be employed between the load current detector 24 in the high side and the variable pulse generator 20 in the low side to communicate the control signal 76 to the variable pulse generator 20. The variable pulse generator 20 and load current detector 24 are both powered by the power output 16 of the rectifier 14, for example through resistors 80 and 82, respectively. The high side, including the load current detector 24, floats at a high potential under the voltage of the input voltage 16 and above the circuit ground 84. A local ground 86 is thus established and used as a reference voltage by the load current detector 24.

A reference current source 90 supplies a reference current signal 92 to the load current detector 24, and a current sensor such as a resistor 94 provides a load current signal 96 to the load current detector 24. The reference current source 90 may use the circuit ground 84 as illustrated in FIG. 6, or the local ground 86, or both, or some other reference voltage level as desired. The load current detector 24 compares the reference current signal 92 with the load current signal 96 using a time constant to effectively average out and disregard current fluctuations due to any waveform at the input voltage 16 and pulses from the variable pulse generator 20, and generates the control signal 76 to the variable pulse generator 20. The variable pulse generator 20 adjusts the pulse width of a train of pulses at the pulse output 100 of the variable pulse generator 20 based on the level shifted control signal 102 from the load current detector 24. The level shifter 74 shifts the control signal 76 from the load current detector 24 which is referenced to the local ground 86 in the load current detector 24 to a level shifted control signal 102 that is referenced to the circuit ground 84 for use in the variable pulse generator 20. The level shifter 74 may comprise any suitable device for shifting the voltage of the control signal 76, such as an opto-isolator or opto-coupler, resistor, transformer, etc.

The pulse output 100 from the variable pulse generator 20 drives a switch 104 such as a field effect transistor (FET) in the output driver 30. When a pulse from the variable pulse generator 20 is active, the switch 104 is turned on, drawing current from the input voltage 16, through the load path 106 (and an optional capacitor 110 connected in parallel with the load 26), through the load current sense resistor 94, an inductor 112 in the output driver 30, the switch 104, and a current sense resistor 114 to the circuit ground 84. When the pulse from the variable pulse generator 20 is off, the switch 104 is turned off, blocking the current from the input voltage 16 to the circuit ground 84. The inductor 112 resists the current change and recirculates current through a diode 116 in the output driver 30, through the load path 106 and load current sense resistor 94 and back to the inductor 112. The load path 106 is thus supplied with current alternately through the switch 104 when the pulse from the variable pulse generator 20 is on and with current driven by the inductor 112 when the pulse is off. The pulses from the variable pulse generator 20 have a relatively much higher frequency than variations in the input voltage 16, such as for example 30 kHz or 100 kHz as compared to the 100 Hz or 120 Hz that may appear on the input voltage 16 from the rectified AC input 12. Note that any suitable frequency for the pulses from the variable pulse generator 20 may be selected as desired, with the time constant in the load current detector 24 being selected accordingly to disregard load current changes due to the pulses from the variable pulse generator 20 while tracking changes on the input voltage 16 that are slower than or on the order of the waveform on the input voltage 16. Changes in the current through the load 26 due to the pulses from the variable pulse generator 20 may be smoothed in the optional capacitor 110, or may be ignored if the load is such that high frequency changes are acceptable. For example, if the load 26 is an LED or array of LEDs, any flicker that may occur due to pulses at many thousands of cycles per second will not be visible to the eye. In the embodiment of FIG. 6, a current overload protection 50 is included in the variable pulse generator 20 and is based on a current measurement signal 120 by the current sense resistor 114 connected in series with the switch 104. If the current through the switch 104 and the current sense resistor 114 exceeds a threshold value set in the current overload protection 50, the pulse width at the pulse output 100 of the variable pulse generator 20 will be reduced or eliminated. The present invention is shown implemented in the discontinuous mode; however with appropriate modifications operation under continuous or critical conduction modes can also be realized.

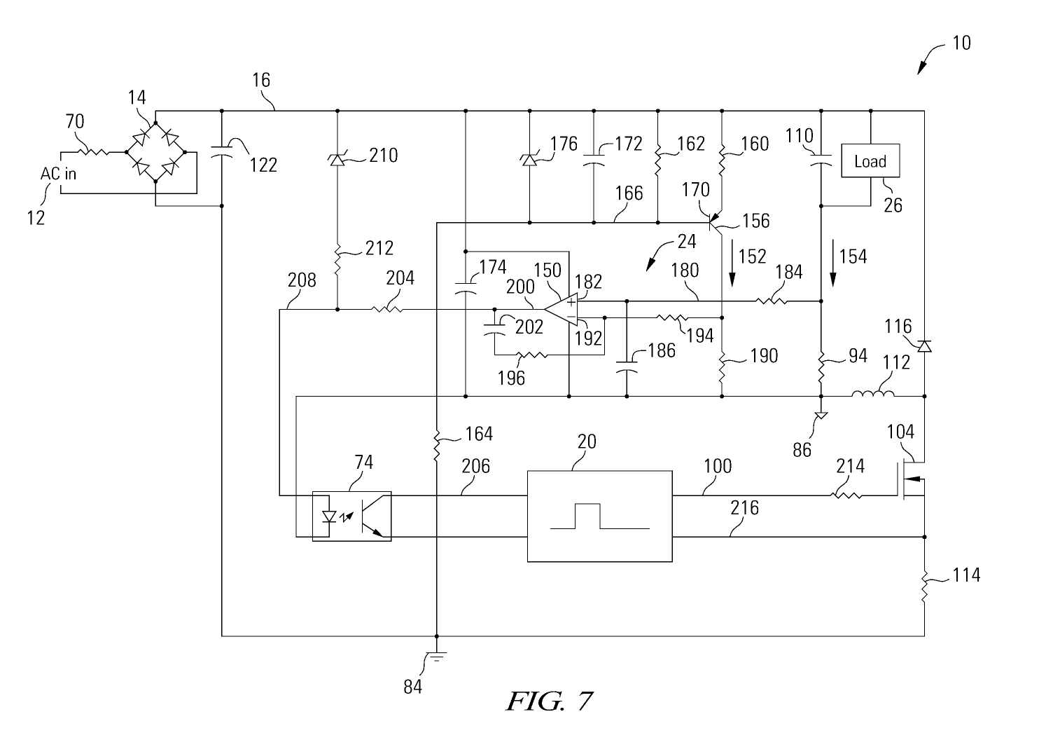

Referring now to FIG. 7, a schematic of one embodiment of the dimmable power supply 10 will be described. In this embodiment, an AC input 12 is used, with a resistor included as a fuse 70, and a diode bridge as a rectifier 14. Some smoothing of the input voltage 16 may be provided by a capacitor 122, although it is not necessary as described above. A variable pulse generator 20 is used to provide a stream of pulses at the pulse output 100. As described above, the variable pulse generator 20 may be embodied in any suitable device or circuit for generating a stream of pulses. Those pulses may have any suitable shape, such as substantially square pulses, semi-sinusoidal, triangular, etc. although square or rectangular are the most common in driving field effect transistors. The frequency of the pulses may also be set at any desired level, such as 30 kHz or 100 kHz, that enable the load current detector 24 to disregard changes in a load current due to the pulses input waveform and also realize a very high power factor (PF) approaching unity. Such an implementation of high power factor, as well as other mechanisms for increasing power factor, is referred to herein as power factor correction (PFC). The width of the pulses is controlled by the load current detector 24, although a maximum width may be established if desired. For example, in one embodiment, the maximum pulse width is set at about one tenth of a pulse cycle. This may be interpreted from one point of view as a 10 percent duty cycle at maximum pulse width. However, the dimmable power supply 10 is not limited to any particular maximum pulse width.

The variable pulse generator 20 is powered from the input voltage 16 by any suitable means. Because a wide range of known methods of reducing or regulating a voltage are known, the power supply for the variable pulse generator 20 from the input voltage 16 is not shown in FIG. 7. For example, a voltage divider or a voltage regulator may be used to drop the voltage from the input voltage 16 down to a useable level for the variable pulse generator 20.

In one particular embodiment illustrated in FIG. 7, the load current detector 24 includes an operational amplifier (op-amp) 150 acting as an error amplifier to compare a reference current 152 and a load current 154. The op-amp 150 may be embodied by any device suitable for comparing the reference current 152 and load current 154, including active devices and passive devices. The op-amp 150 is referred to herein generically as a comparator, and the term comparator should be interpreted as including and encompassing any device, including active and passive devices, for comparing the reference current 152 and load current 154. The reference current 152 may be supplied by a transistor such as bipolar junction transistor (BJT) 156 connected in series with resistor 160 to the input voltage 16. A resistor 162 and a resistor 164 are connected in series between the input voltage 16 and the circuit ground 84, forming a voltage divider with a central node 166 connected to the base 170 of the BJT 156. The BJT 156 and resistor 160 act as a constant current source that is varied by the voltage on the central node 166 of the voltage divider 162 and 164, which is in turn dependent on the input voltage 16. A capacitor 172 may be connected between the input voltage 16 and the central node 166 to form a time constant for voltage changes at the central node 166. The dimmable power supply 10 thus responds to the average voltage of input voltage 16 rather than the instantaneous voltage. In one particular embodiment, the local ground 86 floats at about 10 V below the input voltage 16 at a level established by the load 26. A capacitor 174 may be connected between the input voltage 16 and the local ground 86 to smooth the voltage powering the load current detector 24 if desired. A Zener diode 176 may also be connected between the input voltage 16 and the central node 166 to set a maximum load current 154 by clamping the reference current that BJT 156 can provide to resistor 190. In other embodiments, the load current detector 24 may have its current reference derived by a simple resistive voltage divider, with suitable AC input voltage sensing, level shifting, and maximum clamp, rather than BJT 156.

The load current 154 (meaning, in this embodiment, the current through the load 26 and through the capacitor 110 connected in parallel with the load 26) is measured using the load current sense resistor 94. The capacitor 110 can be configured to either be connected through the sense resistor 94 or bypass the sense resistor 94. The current measurement 180 is provided to an input of the error amplifier 150, in this case, to the non-inverting input 182. A time constant is applied to the current measurement 180 using any suitable device, such as the RC lowpass filter made up of the series resistor 184 and the shunt capacitor 186 to the local ground 86 connected at the non-inverting input 182 of the error amplifier 150. As discussed above, any suitable device for establishing the desired time constant may be used such that the load current detector 24 disregards rapid variations in the load current 154 due to the pulses from the variable pulse generator 20 and any regular waveform of the input voltage 16. The load current detector 24 thus substantially filters out changes in the load current 154 due to the pulses, averaging the load current 154 such that the load current detector output 200 is substantially unchanged by individual pulses at the variable pulse generator output 100.

The reference current 152 is measured using a sense resistor 190 connected between the BJT 156 and the local ground 86, and is provided to another input of the error amplifier 150, in this case, the inverting input 192. The error amplifier 150 is connected as a difference amplifier with negative feedback, amplifying the difference between the load current 154 and the reference current 152. An input resistor 194 is connected in series with the inverting input 192 and a feedback resistor 196 is connected between the output 200 of the error amplifier 150 and the inverting input 192. A capacitor 202 is connected in series with the feedback resistor 196 between the output 200 of the error amplifier 150 and the inverting input 192 and an output resistor 204 is connected in series with the output 200 of the error amplifier 150 to further establish a time constant in the load current detector 24. Again, the load current detector 24 may be implemented in any suitable manner to measure the difference of the load current 154 and reference current 152, with a time constant being included in the load current detector 24 such that changes in the load current 154 due to pulses are disregarded while variations in the input voltage 16 other than any regular waveform of the input voltage 16 are tracked.

The output 200 from the error amplifier 150 is connected to the level shifter 74, in this case, an opto-isolator, through the output resistor 204 to shift the output 200 from a signal that is referenced to the local ground 86 to a signal 206 that is referenced to the circuit ground 84 or to another internal reference point in the variable pulse generator 20. A Zener diode 210 and series resistor 212 may be connected between the input voltage 16 and the input 208 of the level shifter 74 for overvoltage protection. If the voltage across load 26 rises excessively, the Zener diode 210 will conduct, turn on the level shifter 74 and reduce the pulse width or stop the pulses from the variable pulse generator 20. There are thus two parallel control paths, the error amplifier 150 to the level shifter 74 and the overvoltage protection Zener diode 210 to the level shifter 74.

The error amplifier 150 operates in an analog mode. During operation, as the load current 154 rises above the reference current 152, the voltage at the output 200 of the error amplifier 150 increases, causing the variable pulse generator 20 to reduce the pulse width or stop the pulses from the variable pulse generator 20. As the output 200 of the error amplifier 150 rises, the pulse width becomes narrower and narrower until the pulses are stopped altogether from the variable pulse generator 20. The error amplifier 150 produces an output proportional to the difference between the average load current 154 and the reference current 152, where the reference current 152 is proportional to the average input voltage 16.

As discussed above, pulses from the variable pulse generator 20 turn on the switch 104, in this case a power FET via a resistor 214 to the gate of the FET 104. This allows current 154 to flow through the load 26 and capacitor 110, through the load current sense resistor 94, the inductor 112, the switch 104 and current sense resistor 114 to circuit ground 84. In between pulses, the switch 104 is turned off, and the energy stored in the inductor 112 when the switch 104 was on is released to resist the change in current. The current from the inductor 112 then flows through the diode 116 and back through the load 26 and load current sense resistor 94 to the inductor 112. Because of the time constant in the load current detector 24, the load current 154 monitored by the load current detector 24 is an average of the current through the switch 104 during pulses and the current through the diode 116 between pulses.

The current through the dimmable power supply 10 is monitored by the current sense resistor 114, with a current feedback signal 216 returning to the variable pulse generator 20. If the current exceeds a threshold value, the pulse width is reduced or the pulses are turned off in the variable pulse generator 20. Generally, current sense resistors 94 and 114 may have low resistance values in order to sense the currents without substantial power loss. Thermal protection may also be included in the variable pulse generator 20, narrowing or turning off the pulses if the temperature climbs or if it reaches a threshold value, as desired. Thermal protection may be provided in the variable pulse generator 20 in any suitable manner, such as using active temperature monitoring, or integrated in the overcurrent protection by gating a BJT or other such suitable devices, switches and/or transistors with the current feedback signal 216, where, for example, the BJT exhibits negative temperature coefficient behavior. In this case, the BJT would be easier to turn on as it heats, making it naturally start to narrow the pulses.

In one particular embodiment the load current detector 24 turns on the output 200 to narrow or turn off the pulses from the variable pulse generator 20, that is, the pulse width is inversely proportional to the load current detector output 200. In other embodiments, this control system may be inverted so that the pulse width is directly proportional to the load current detector output 200. In these embodiments, the load current detector 24 is turned on to widen the pulses.

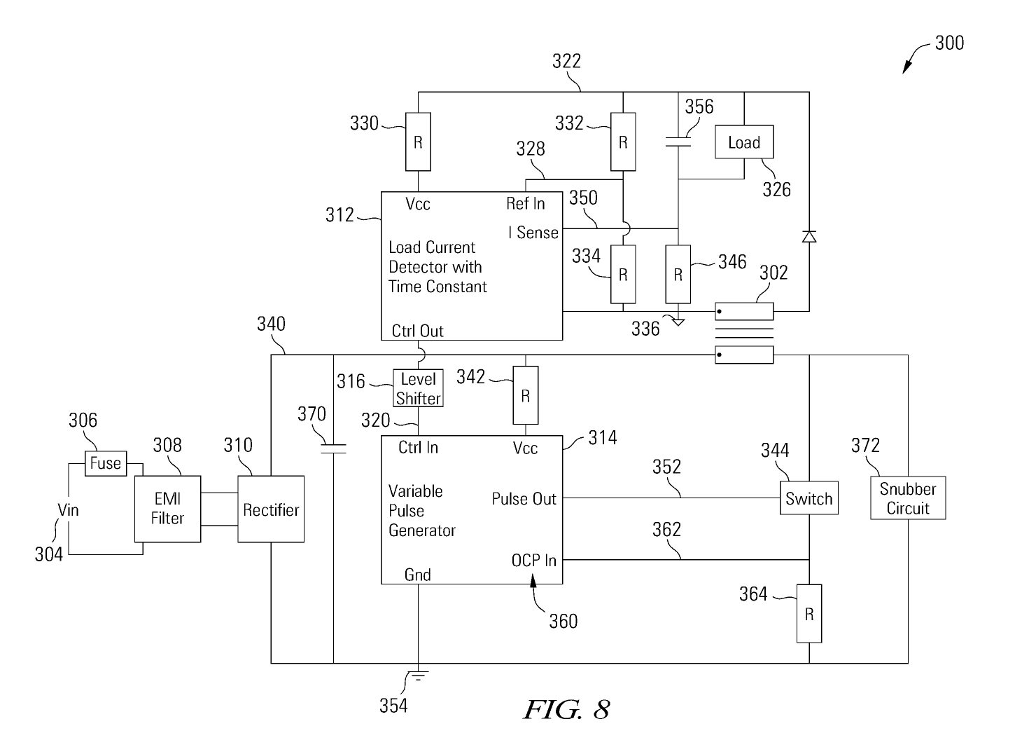

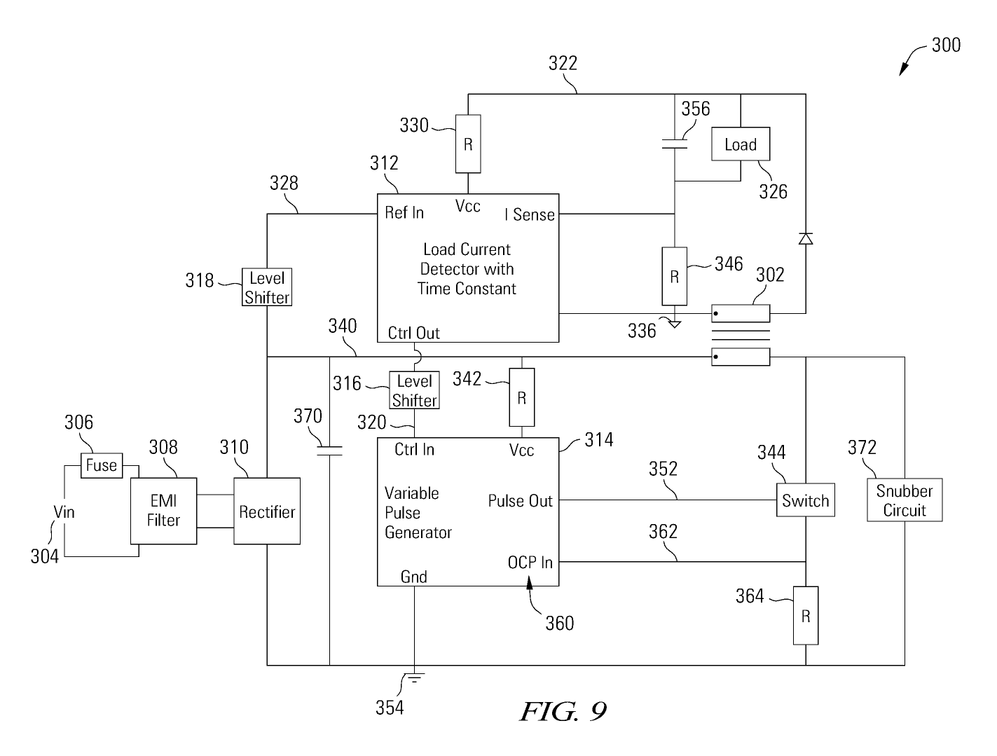

In applications where it is useful or desired to have isolation between the load and the input voltage source, a transformer can be used in place of the inductor. The transformer can be of essentially any type including toroidal, C or E cores, or other core types and, in general, should be designed for low loss. The transformer can have a single primary and a single secondary coil or the transformer can have either multiple primaries and/or secondaries or both. FIG. 8 illustrates one embodiment using a transformer in the flyback mode of operation to realize a highly efficient circuit with very high power factor approaching unity and with isolation between the AC input and the LED output. (For example, in some embodiments, power factor is above about 0.98, and in some cases, 0.995 or above.) Such an implementation of high power factor is referred to herein as power factor correction. Such an embodiment can also readily support internal dimming as illustrated in FIG. 9. In other embodiments, other types of energy storage devices may be used in place of or in conjunction with an inductor or a transformer, in order generally to store energy when the switch is closed and to transfer the stored energy to the load output when the switch is open or to otherwise transfer energy from the power input to the load output. For example, in some embodiments, a capacitor may be used as an energy storage device.

Referring now to FIG. 8, a non-dimming power supply 300 with a transformer 302 will be described. An AC input 304 is shown, and is connected to the dimmable power supply 300 in this embodiment through a fuse 306 and an electromagnetic interference (EMI) filter 308. As in previously described embodiments, the fuse 306 may be any device suitable to protect the dimmable power supply 300 from overvoltage or overcurrent conditions. The AC input 304 is rectified in a rectifier 310. In other embodiments, the dimmable power supply 300 may use a DC input. The dimmable power supply 300 may generally be divided into a high side portion including the load current detector 312 and a low side portion including the variable pulse generator 314. The high side portion is connected to one side of the transformer 302, such as the secondary winding, and the low side portion is connected to the other side of the transformer 302, such as the primary winding. A level shifter 316 is employed between the load current detector 312 in the high side and the variable pulse generator 314 in the low side to communicate the control signal 320 to the variable pulse generator 314. The high side has a node that may be considered a power input 322 for the output driver, although the power for the power input 322 is derived in this embodiment from the transformer 302. The load 326 receives power from the power input 322. The load current detector 312 is also powered from the power input 322 through a resistor 330, and a reference current 328 for the load current detector 312 is generated by a voltage divider having resistors 332 and 334 connected in series between the power input 322 and a high side or local ground 336. The variable pulse generator 314 is powered from a low side input voltage 340 through a resistor 342, and a switch 344 driven by pulses from the variable pulse generator 314 turns on and off current through the transformer 302. The power supply voltage to the load current detector 312 may be regulated in any suitable manner, and the reference current input 328 may be stabilized as desired. For example, a voltage divider with a clamping Zener diode may be used as in previous embodiments, a precision current source may be used in place of the resistor 332 in the voltage divider, a bandgap reference source may be used, etc. Note that it is important in dimmable embodiments for the input voltage 340 to be a factor in the reference current input 328 such that this input 328 is clamped at some maximum value as the input voltage 340 rises, yet is allowed to fall as input voltage 340 drops (suitably filtered to reject the AC line frequency).

In the high side, as current flows through the load 326, a load current sense resistor 346 provides a load current feedback signal 350 to the load current detector 312. The load current detector 312 compares the reference current signal 328 with the load current signal 350 using a time constant to effectively average out and disregard current fluctuations due to any waveform at the power input 322 and pulses from the variable pulse generator 314 through the transformer 302, and generates the control signal 320 to the variable pulse generator 314. The variable pulse generator 314 adjusts the pulse width of a train of pulses at the pulse output 352 of the variable pulse generator 314 based on the level shifted control signal 320 from the load current detector 312. The level shifter 316 shifts the control signal 320 from the load current detector 312 which is referenced to the local ground 336 by the load current detector 312 to a level shifted control signal that is referenced to the circuit ground 354 for use by the variable pulse generator 314. The level shifter 316 may comprise any suitable device for shifting the voltage of the control signal 320 between isolated circuit sections, such as an opto-isolator, opto-coupler, resistor, transformer, etc.

The pulse output 352 from the variable pulse generator 314 drives the switch 344, allowing current to flow through the transformer 302 and powering the high side portion of the dimmable power supply 300. As in some other embodiments, any suitable frequency for the pulses from the variable pulse generator 314 may be selected, with the time constant in the load current detector 312 being selected to disregard load current changes due to the pulses from the variable pulse generator 312 while tracking changes on the input voltage 322 that are slower than or on the order of the waveform on the input voltage 322. Changes in the current through the load 326 due to the pulses from the variable pulse generator 314 may be smoothed in the optional capacitor 356, or may be ignored if the load is such that high frequency changes are acceptable. Current overload protection 360 may be included in the variable pulse generator 314 based on a current measurement signal 362 by a current sense resistor 364 connected in series with the switch 344. If the current through the switch 344 and the current sense resistor 364 exceeds a threshold value set in the current overload protection 360, the pulse width at the pulse output 352 of the variable pulse generator 314 will be reduced or eliminated. A line capacitor 370 may be included between the input voltage 340 and circuit ground 354 to smooth the rectified input waveform if desired. A snubber circuit 372 may be included in parallel, for example, with the switch 344 if desired to suppress transient voltages in the low side circuit. It is important to note that the dimmable power supply 300 is not limited to the flyback mode configuration illustrated in FIG. 8, and that a transformer or inductor based dimmable power supply 300 may be arranged in any desired topology.

Referring now to FIG. 9, the power supply 300 with a transformer 302 may be adapted for dimmability by providing level-shifted feedback from the AC input voltage 340 to the load current detector 312. The level shifter 318 may comprise any suitable device as with other level shifters (e.g., 316). The level-shifted feedback enables the load current detector 312 to sense the AC input voltage 340 so that it can provide a control signal 320 that is proportional to the dimmed AC input voltage 340.

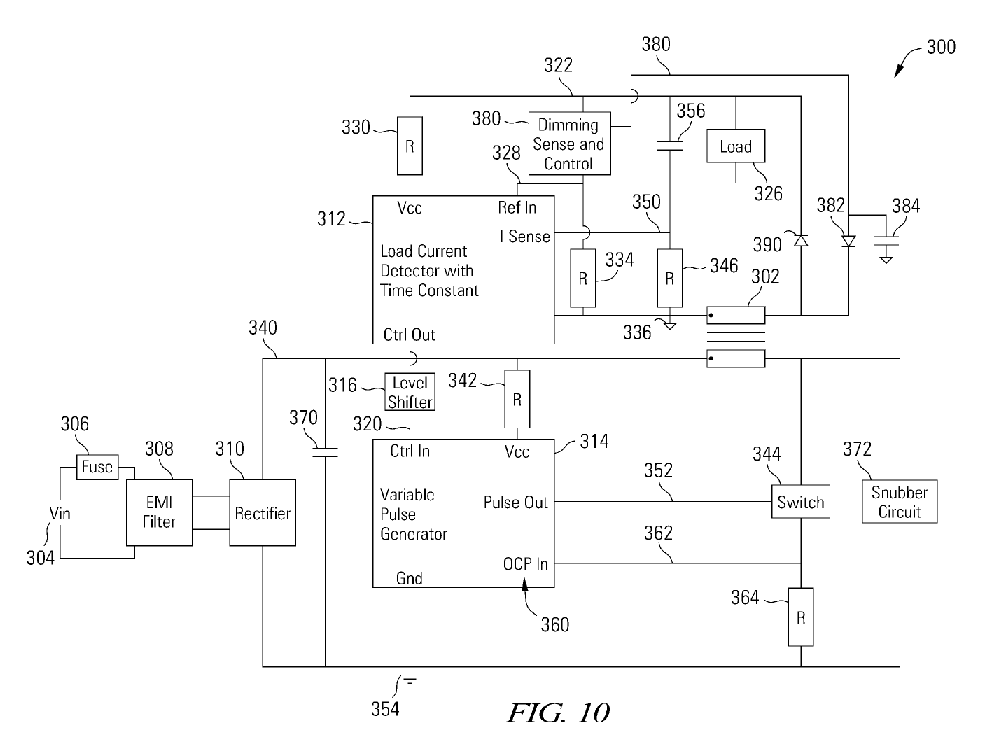

Referring now to FIG. 10, the dimmable power supply 300 may also include an internal dimmer 380, for example, to adjustably attenuate any of a number of reference or feedback currents. In the embodiment of FIG. 9, the dimmable power supply 300 is placed to adjustable control the level of the reference current 328. The reference current 328 generated by the internal dimmer 380 may be based on the input voltage 340 in the low side or primary side of the dimmable power supply 300 via a feedback signal 380 through the transformer 302. Diode 382 may be included to ensure that current on the internal dimmer 380 flows only in one direction, and capacitor 384 may be added to introduce a time constant on the internal dimmer 380. For example, referring to FIGS. 7 and 10 simultaneously, if the high side of the dimmable power supply 300 of FIG. 9 were configured similar to that of the dimmable power supply 10 of FIG. 7, the bottom of resistor 164 may be connected to the internal dimmer 380 rather than to the circuit ground 84. Note also that diode 390 may not be needed if the dimmable power supply 300 is not configured for operation in flyback mode.

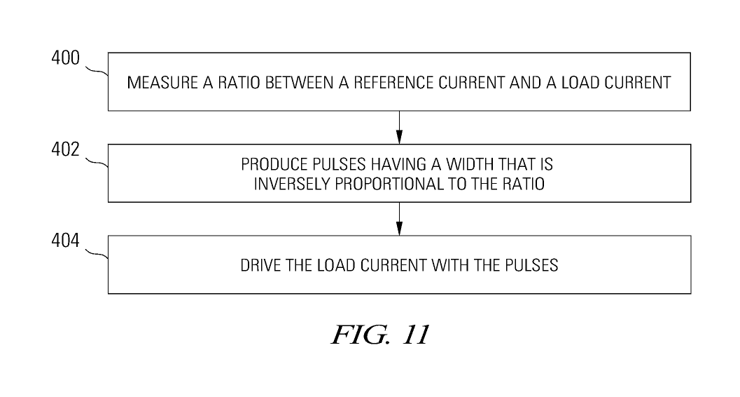

Turning now to FIG. 11, one embodiment of a method for dimmably supplying a load current is summarized. The method includes measuring a ratio between a reference current 152 and a load current 154 (block 400), producing pulses having a width that is inversely proportional to the ratio (block 402), and driving the load current with the pulses (block 404. As described above, the measuring is performed with a time constant that substantially filters out the pulses in the load current 154 but substantially passes changes in the reference current 152. Note, however, that a time constant is applied to the reference current 152 as well, thereby considering an average input voltage 16 rather than instantaneous. The time constant applied to the reference current 152 may be varied as desired, however, to maintain a high power factor the pulse width should be constant across an input waveform on the input voltage 16. In some embodiments, the pulse width is kept substantially constant across a cycle of the input voltage waveform. Given the feedback and control of the dimmable power supply 10 and 300, there may be changes in the pulse width across a cycle of an input waveform when the load current is being held constant despite noise on the input voltage, or when the load current is being varied by an external or internal dimmer. The statement that the pulse width will be kept substantially constant across a cycle of the input waveform does not preclude these changes to the pulse width that may occur partially or entirely across a cycle of the input waveform, but indicates in these embodiments that the pulse width is not substantially varied in direct response to the rising and falling input voltage due to the waveform itself, such as to the half sinusoidal peaks of a rectified AC waveform.

The dimmable power supply 10 disclosed herein provides an efficient way to power loads such as LEDs with a good power factor, while remaining dimmable by external or internal devices.

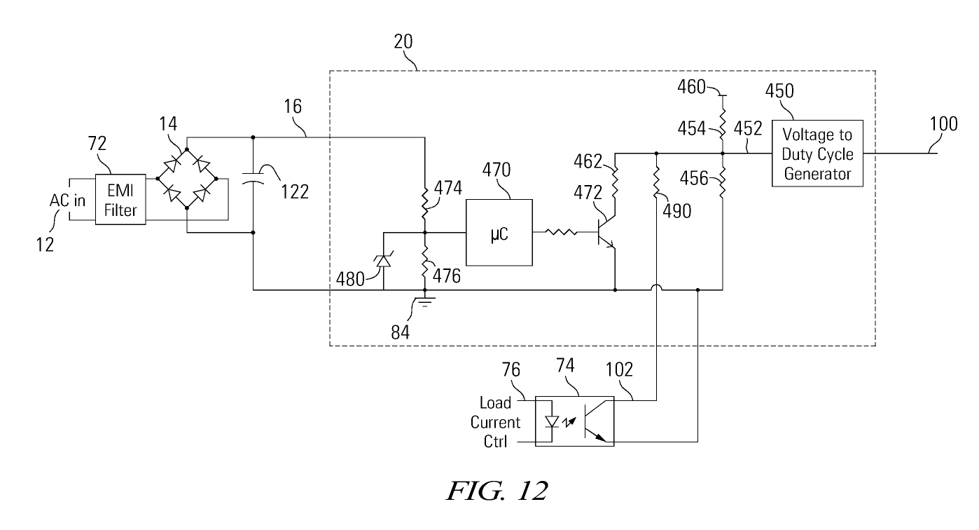

Turning to FIG. 12, a universal dimmer controller is disclosed which may be incorporated into a dimming driver such as any of those disclosed herein, or their variations. In some embodiments, the universal dimmer controller disclosed in FIG. 12 is used in place of the variable pulse generator 20 and level shifter 74 of FIG. 6, accepting control signal 76 and generating pulse output 100. The universal dimmer controller enables the driver circuit to switch from dimming mode to universal voltage input operation based on the phase angle of a dimmer such as a Triac or other forward or reverse dimmer. Such a switch/change in modes can be accomplished by a number of methods including manual mode via, for example, a switch that can be manually moved to change the value of a circuit component or parameter such as a resistor or voltage, respectively, to change the circuit operation from a constant current regardless of the input voltage (peak, average, etc.) within reasonable limits to a circuit operation that responds to input values and in particular the input voltage whether the peak, average or some combination of such values, etc. Such a dimming operation may have multiple states and conditions, for example, there could be four choices to select from: dimming in a range of lower voltages (i.e., 90 to 125 VAC or a more narrow range, etc.), universal input with constant current or constant voltage, dimming in a range of higher voltages (i.e., 200 to 220 VAC, 220 to 240 VAC, or a more narrow range, etc.), or dimming over a large range such as 80 VAC to 305 VAC. Although a typical application may use AC, the input voltage could be AC and/or DC.

One example of a variable pulse generator 20 and 314 that supports universal dimming is illustrated in FIG. 10, although it is important to note that the variable pulse generator 20 and 314 may be adapted in any suitable manner to limit the input voltage as needed to cap the output current given various different input voltages or input voltage ranges. In this example embodiment, the variable pulse generator 20 is adapted with several mechanisms for limiting the pulse width at the pulse output 100. The pulse train is generated by a voltage to duty cycle pulse generator 450, which adjusts the duty cycle or pulse width proportionally to the voltage at the input 452. As the voltage increases, the pulse width or duty cycle increases. The free-running non-limited pulse width is established by a bias voltage at the input 452, such as that produced by divider resistors 454 and 456 from a reference voltage 460. For example, a 15V reference voltage 460 may be used with 100 kΩ and 30 kΩ resistors 454 and 456 to produce a bias voltage at the input 452 of about 3.5V for a maximum pulse width. Various mechanisms may be used to lower the voltage at the input 452 during over-current or over-temperature conditions, for example. The values and voltages listed are merely for illustrative purposes and should not be construed as limiting in any way or form for the present invention.

One such mechanism in the example embodiment of FIG. 20 is the addition of another slope resistor 462 in parallel with the first slope resistor 456 if the input voltage rises above a particular level. For example, the variable pulse generator 20 may be adapted to operate with either a 120 VAC input or a 240 VAC input and to detect which is being used. By connecting a second 30 kΩ slope resistor 462 in parallel with the first slope resistor 456, the voltage at the input 452 to the pulse generator 450 is cut in half and the rate of increase in the duty cycle slope is cut in half as the input voltage is dimmed. Note that when the input voltage is dimmed by an external dimmer, the input voltage range is typically either 0 VAC-120 VAC or 0 VAC-240 VAC as illustrated and discussed in the present example. However, other examples and embodiments of the present invention can allow for wider, broader or narrower voltage ranges as desired or required, etc.

Any suitable mechanism for connecting the second slope resistor 462 (or otherwise changing the value of the first slope resistor 456) may be used. For example, a microcontroller 470 or suitable alternatives may monitor the input voltage 16 and turn on a transistor 472 such as an NPN bipolar transistor to connect the second slope resistor 462. Such alternatives may include microprocessors, digital signal processors (DSPs), state machines, digital logic, analog and digital logic, application specific integrated circuits (ASICs), field programmable gate arrays (FPGAs), configurable logic devices (CLDs), etc. In this example, the microcontroller 470 monitors the input voltage 16 using an analog to digital converter (ADC) input connected to the input voltage 16 through voltage divider resistors 474 and 476, which scale the expected maximum voltage of 240 VAC (rectified to about 340 VDC) at the input voltage 16 to the maximum input level of the ADC, or about 3 VDC or a bit below. A Zener diode 480 may be connected to the ADC to limit the input voltage to the maximum supported by the microcontroller 470 to prevent damage to the microcontroller 470. When operating at 120 VAC input and dimmed fully on, the input to the ADC in the microcontroller 470 is about 1.5 VDC. The microcontroller 470 in this example is programmed to turn on the transistor 472 and connect the second slope resistor 462 when the input voltage rises above about 1.5 VDC, meaning that the AC input 12 is above about 120 VAC. The variable pulse generator 20 may be adapted if desired to perform this input voltage detection and secondary slope resistor switching only periodically or only at startup, and to keep the secondary slope resistor 462 active once connected until the next power cycle, to avoid switching back and forth between input voltage ranges and flashing the LEDs. Any suitable method including hardware, firmware, software, algorithms, etc. may be used. Note that MOSFETs, junction FETs, any most any other type of transistor could be used in place of the BJT 472 shown in FIG. 10.

A similar mechanism may be used to reduce or limit the pulse width when the load current reaches its maximum allowable value. When the load current detector 24 (e.g., FIG. 4) determines that the load current has reached the maximum value, it begins to turn on the load current control signal 76. The control signal 76 is level shifted or isolated as needed by a device such as the level shifter 74. A third slope resistor 490 is connected in series with the level shifter 74 output across the first slope resistor 456, so that as the level shifter 74 is activated, it lowers the effective resistance between the pulse generator input 452 and circuit ground 84, reducing the voltage at the pulse generator input 452. The level shifter 74 is turned on in analog fashion by the load current detector 24, turning on more strongly as the load current rises above the maximum allowable level. The third slope resistor 490 is given a value low enough to turn off the pulses or restrict them as desired to protect the load from excessive current. For example, the third slope resistor 490 may be a 1 kΩ, so that when the level shifter 74 is only slightly turned on, the combination of the third slope resistor 490 and the level shifter 74 may present a 30 kΩ resistance in parallel with the first slope resistor 456, and when the level shifter 74 is fully on, 1 kΩ is connected in parallel with the first slope resistor 456. Although primarily illustrated for two dimming input voltage ranges (N=2), any number of ranges (N=1, 2, 3, 4, 5 . . . ) may be used and selected with the present invention. In addition, the example illustrative circuit shown in FIG. 10 may be adapted, modified, changed, etc. to respond to and have different inputs as well as different outputs or connections for the outputs, etc.

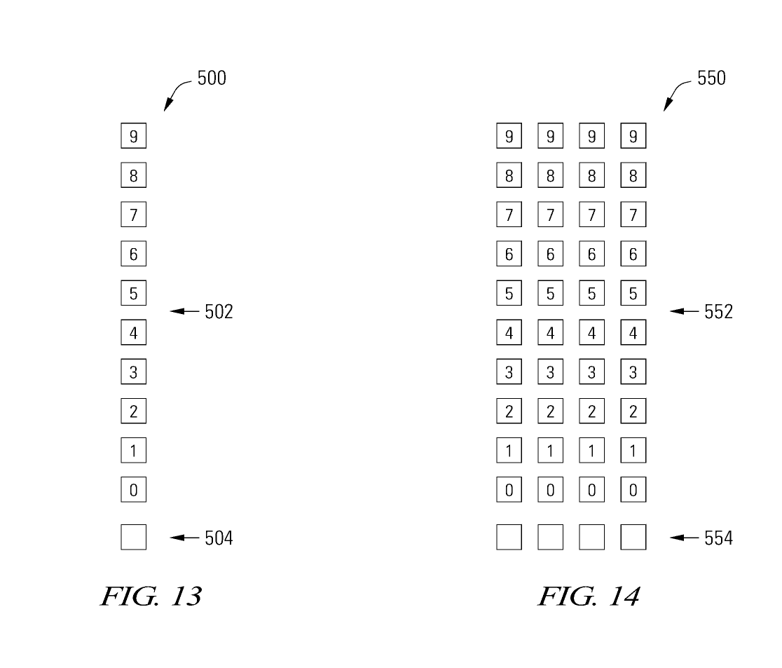

An interface for dimmable dimmers is also disclosed herein that can be used to provide signals for power for lights such as LEDs of any type, including organic LEDs (OLEDs), as well as other loads, including but not limited to, fluorescent lamps (FLs) including, and also not limited to, compact fluorescent lamps (CFLs), energy efficient FLs, cold cathode FLs (CCFLs), high intensity discharge lamps (HIDs), etc. In addition, such an interface can be used for, for example, remote control and dimming of multiple light sources including multi-color and white light sources such as a white (W) plus red-green-blue (RGB) light source (W+RGB) as disclosed and discussed in US patent application Ser. No. 13/098,768, filed May 2, 2011, for “Remotely Controlled Lighting”, which is incorporated herein by reference for all purposes. The present invention allows, for, for example, simultaneous control and dimming of four channels of light: W+RGB. An example embodiment of the present invention is illustrated in FIG. 13 in which a computer, tablet, mobile device such as a smart phone or tablet or related device (e.g., iphone, ipad, ipod, Android phone or Android tablet, other smartphones, Kindle, etc.) interfaces to a web browser (or other method of connectivity including via a cellular phone network, satellite links, cell phone provider, land line provide, cable provider, etc.) via, for example a WiFi enabled controller board that is able to communicate with the various light sources, including, but not limited, to white light sources (including, but not limited to, LED, fluorescent lamps (FLs), compact fluorescent lamps (CFLs), cold cathode fluorescent lamps (CCFLs), incandescent lamps, other types of cold cathode lamps, HIDs, etc.), W+RGB LEDs, W+RGB FLs, CFLs, CCFLs, HIDs, etc., RGB FLs, CFLs, CCFLs, etc., by, for example, wired, wireless, powerline, infrared (IR) etc. interfaces. Such an interface can, for example, have a graphical user interface (GUI) and/or a text user interface (TUI) to display one or more elements (N) of light control and dimming and in particular, N=4 or, for example, multiples of N=4 for W+RGB control. (N is not limited to 4 or multiples of four, but can be any other number. For example, the interface may be operable to control one or more varieties of white light sources and one or more varieties of colored light sources, such as a white LED and two colored LEDs, three colored LEDs, four colored LEDs, etc.) One embodiment of the present invention displays four dimmable elements with one element corresponding to white, one element corresponding to red, one element corresponding to green and one element corresponding to blue. Of course other colors in addition to or instead of W+RGB can be used with the present invention. With the present invention and the embodiment described above, W, W+RGB and RGB light sources can be dimmed, switched off, monitored, controlled, logged, etc. from the present invention interface. Such an embodiment of the present invention can take the form of four sets of sliders, four sets of knobs, including rotary knobs, four sets of buttons, etc, or in general, N sets of sliders, knobs, buttons, etc. of any type of form. In addition, although mentioned in the context of an interface using remote control from a mobile device or devices, the present invention can also be directly attached via wired, wireless or powerline to the lighting sources without the need for an external remote control or mobile device. Such embodiments can use a physical arrangement of N set of sliders, switches, buttons, knobs, etc. rather than a software or firmware GUI or TUI. In other embodiments both a physical and GUI/TUI set or sets of switches, sliders, knobs, buttons, etc. may be used and implemented. Such implementations and embodiments of the present invention may use the physical and firmware/software GUI/TUI in conjunction with each other where, for example, information is shared, coordinated, synchronized and communicated between the physical and GUI/TUI N sets or is separately and individually controlled and acted upon. The button, knobs, keys, etc. can be color coded/displayed to, for example, match the type and color of light source or may be coded/displayed/etc. in any other desired way, format, grouping, etc.

Colors may be selected using a color palette, a grid presenting predefined colors that can be selected to control both colored light sources and white light sources, to set both the overall output color and intensity. Colors may also be selected using a color wheel, or a color spectrum plot, providing a more continuous range of possible colors and intensities. Such a color wheel or color spectrum plot may be laid out in any desired manner, such as a circle with varying hues around the circumference of the circle and with varying intensities along radial hue lines from the center to the edge of the circle, or a square or rectangle with hues varying along one axis and intensities varying along another axis. The interface for dimmable drivers is not limited to any particular manner of selecting colors and intensities, whether graphical or text-based.

Control of white light levels is provided in some embodiments along with the color selection, for example providing a graphical or text-based white light control along with a color selector such as a color wheel. Such a white light control may be, for example, a graphical element in an interface accessible using a smart phone, an ipod, a tablet, or a computer, etc, such as a slider or other graphical element, or a series of tap locations to select various white intensities, or may be a physical control such as a knob, slider switch, keys, etc. to select the white intensity. The selected white intensity level may be used to control one or more white light sources such as white LEDs, and/or colored light sources controlled together to produce an overall white light output.

The interface may also provide predefined colors and intensities that may be user-defined and stored in or otherwise accessible by a server or driver, and that may be labeled or tagged with identifiers such as moods, labels, entities, identities, special words, descriptors, or numbers or other identifiers. Such labeled, tagged, etc. identifiers may also be combined in any way desirable or useful including sequencing, synchronizing, random combinations, aligning, etc. Such labeled, tagged, etc. identifiers that may be combined in any way, including the ways above, may also be shared in any way or form including, but not limited to, wireless transfer, text message, e-mail, voice commands, cellular phone transfer of any type or form, social media, social content sites, social websites, video games, web-based chatting, interactive web and web-based devices, blogs, televisions, web-based devices, ipods, iphones, ipad, droid phones and tablets, other tablets and phone including smart phones, RF, infrared, microwave, proximity, Bluetooth, or any other direct or indirect connection, syncing up, downloading, be an e-mail, attachment to an e-mail, uploaded and downloaded to a website, etc. For example, in some embodiments, an app for a mobile device may be adapted to accept user input for color and intensity selection, to store colors and intensity settings with labels or tags, to share the stored settings with other users in any manner, and to import and apply stored settings from other users or from previous operations. The stored settings may have any suitable format, such as a text or binary format file, form data, java, HTML, etc., and may be communicated in any suitable manner, such as a download from a web server, or embedded in a text message, email, APP(s), or any other communication packet, etc. Stored settings may also be used to edit, modify, augment, supplement, enhance, systematically or randomly change dimming settings, etc.

The present invention can manifest itself and have embodiments that include, for example, in any combination or selection of an RGB GUI or TUI and a white light GUI and/or TUI where the white light, intensity, level, dimming level, etc. can be part of the RGB GUI and/or TUI or linked to the RGA GUI and/or TUI, or reside next to the RGB GUI and/or TUI, be inside of the RGB GUI and/or TUI, be superimposed on the RGB GUI and/or TUI, be part of the GUI and/or TUI, be expandable, be a subset, be separate, from, be on the same or a different web page, web-site, APP page, etc. Implementations of the present invention include and cover any and all forms and kinds and types, etc. of RGB plus white light control, monitoring, dimming, intensity, adjusting using any type of interface including remote interfaces, dimming interfaces, PWM interfaces, analog and/or digital interfaces, electronic interfaces, mechanical interfaces, electromechanical interfaces, electromagnetic interfaces, etc. The interfaces can have any type of display including liquid crystal display (LCD), light emitting diode (LED), plasma displays (PD), vacuum fluorescent displays (VFDs), field emitter displays (FEDs), etc. or no display. The present invention can use colors other than RGB+white, for example, RGBA+White, or in general, XYZ+White, UVWXYZ+White, where U, V, W, X, Y, and Z can either represent a color or, for example, a combination of colors or one or more of U, V, W, X, Y, and Z may represent no color; with at least one or more of U, V, W, X, Y, and Z representing a color. The present invention includes any type of N+white interface where the N colors can be controlled separately of the white color. The present invention includes any type of N+white interface where the N colors can be controlled along with the white color. The present invention includes any type of N+white interface where the N colors can be controlled independently of the white color. The present invention includes any type of N+white interface where the N colors can be controlled in conjunction with the white color in any way or form. The white color may include, for example a white light source of any type such as, but not limited to, an overhead white light source, a desk lamp, a night lamp, a bed side lamp, a reading lamp, a room lamp, a task lamp, an area lamp or light source, an under the counter lamp, a room lamp, a down light lamp, a track lamp of any type and voltage and current including low voltage and high voltage and power track lamps, an incandescent lamp, a halogen lamp, a fluorescent lamp, a high intensity lamp of any kind, etc. connected to or integrated or assembled with, etc. a one or more color source, a two or more color source, a three or more color source, a four or more color source, etc. The present invention can be used for setting a mood, setting a task, setting a set and/or suite of conditions, controlling and monitoring the lighting tone, mood, environment, etc. The present invention can be used to monitor any and all features, parameters, conditions, mood, settings, environment, electrical, optical, temperature, etc. information and store any and all information including color settings, color+white settings, combinations, color settings, color plus white settings with other audio, visual, sensory, vibration, mechanical, electrical, optical information, data, parameters, etc. Such storage can be of any type including, but not limited to local, mobile based device, cellular phone based, tablet based, remote control based, web based, cloud based, etc. Such stored information can be shared and transferred to others including, but not limited to, other mobile based device, cellular phone based, tablet based, remote control based, web based, cloud based, etc.

The power source for the present invention can be any suitable power source including but not limited to linear regulators and/or switching power supplies and regulators, transformers, including, but not limited to, forward converters, flyback converters, buck-boost, buck, boost, boost-buck, cuk, etc. Embodiments of the present invention can use dual/AC opto-couplers/opto-isolators/etc., coils, transformers, windings, etc. The present invention is not limited to the choices discussed above and any suitable circuit, topology, design, implementation, method, approach, etc. may be used with the present invention.

Although the example embodiment shown in FIG. 13 uses buttons 500 and has 10 discrete levels, there is essentially no limit to the number of discrete or continuous steps that the present invention could have; for example instead of ten steps there could be 256 steps for each of the N channels, or in general any number of steps including 2 raised to the power of M where M>=0 and typically 4, 8, 10, etc. The choice of the number of steps, whether continuous, discrete, analog-like, or digital-like, etc. in these example embodiments should not be construed to be limiting in any way or form. In addition, there can be selection of the resolution or number of steps by the user where, for example, the user can specify the number of steps or select various options such as course, fine, ultrafine, etc. These types of choices, selections, etc. can be displayed automatically, manually, or by any other method, way, approach, implementation, etc. For example, these can be selected via physical commands, methods, and ways, such as, but not limited to, touching, typing, moving, speaking, tones, including tone of voice, using a mouse or cursor, pen, etc., vibration, light, etc. The GUI/TUI could also have keys, buttons, knobs, etc. that allow the resolution to be adjusted from very course to ultra-fine permitting, for example, a nearly infinite number of dimming settings and levels and combinations, etc. In some embodiments, as in FIG. 14, buttons 550 provide for control of multiple driver channels, for example to control multiple colors in a lighting system to form a desired blended color. In FIG. 14, each column of buttons 550 adjust the intensity of a different channel, such as but not limited to a white channel, red channel, green channel and a blue channel. The interfaces of FIGS. 13 and 14, in some embodiments, are graphical interfaces that may be displayed in any web browser, with buttons 502, 552 that may be clicked to select an intensity level, and text entry boxes 504, 554 in which an intensity value may be entered, such as a value from 0-255. Again, any other graphical and/or text based interface may also be used.

Custom-designed interfaces including ones created by the user can also be used in implementations of the present invention. There can be multiple pages and folders that can be automatically, manually, auto-detected, etc. customized to the lighting environment, for example, either in a dynamic or static mode. Such auto-detect/auto-select can be used to control the lighting, for example, in such a way as to only display the allowable/selectable lighting control options for a given lighting environment. Of course manual selection and other methods can be utilized as well as low cost and simpler methods and implementations of the present invention. The present invention allows multiple lighting sources and applications to be controlled by the same interface. For example, task lighting, desktop lighting, desk lamps, night lamps, bedside lamps, overhead lamps and lights, downlight lamps and lights, etc. could all be controlled by the same interface such that all white lighting could be turned on or off or dimmed at the same time/simultaneously as well as all color lighting including but not limited to RGB color lighting (which can be mixed to produce the appearance of white light).

Certain embodiments of the present invention can also be used to set the color temperature, color rendering index (CRI), of the white lighting sources as well as select the effective color temperature of the white lighting and the dimming level of the white lighting. The present invention can also be used to make light shows where the colors of the light can depend on various inputs and stimuli including, but not limited to, audio (including digital or analog generated music from any source including the iPhone, iPod, iPad, Android phone, Android tablet, etc.), other sounds and vibrations, randomly generated signals, other light sources, smells, tactile and/or touch interfaces, etc.

The present invention can also use applications (Apps) either specifically or generally designed for the particular mobile device such as an iPhone, Android phone, Android tablet, iPad, iPod, etc. The present invention can also allow manual and/or automatic firmware and software upgrades to, for example, the mobile device applications, if any, and the controller that interfaces with lighting sources and also the lighting sources themselves and even, for example, the lighting source drivers and internal controllers. Certain embodiments of the present invention can be also monitor, log, store, etc. the states and conditions of the light sources including but not limited to the dimming level, the color combinations/selections/levels/etc., the on-off status and state, the power level, the efficiency, the power factor, the input and output current, voltage and power, etc.

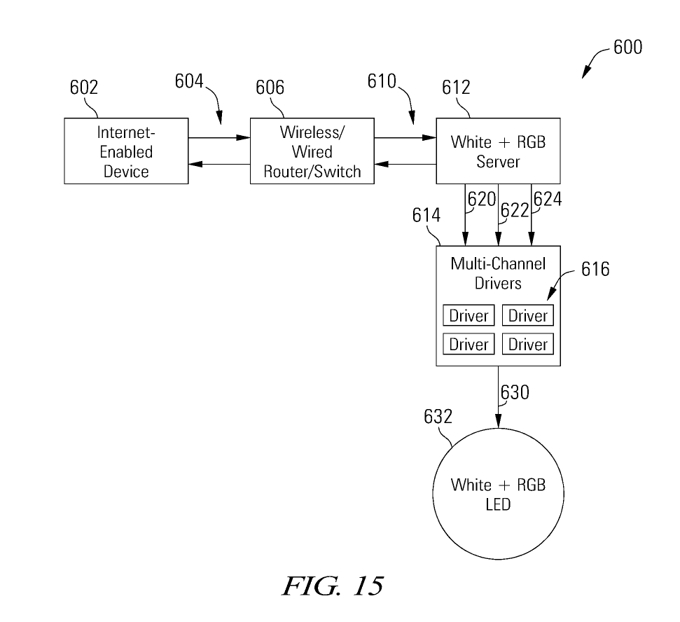

FIG. 15 provides a simple block diagram of a dimmable driver system and interface 600 in accordance with some embodiments of the present invention. An internet-enabled device 602, such as a computer, tablet or mobile device is connected by either or both a wireless or wired connection 604 to a wired and/or wireless switch or router 606. A wired and/or wireless connection 610 connects the switch or router 606 to a multichannel web server 612. In some embodiments, the multichannel web server 612 provides a user interface to set white, red, green and blue dimming levels or intensities. For example, one or more web pages implementing a dimming driver graphical and/or text based interface may be stored on and accessible from the multichannel web server 612. In some embodiments, the user interface is implemented either partially or completely on the internet-enabled device 602, for example as an app on a smartphone, tablet or other device. In some of these embodiments, the multichannel web server 612 is adapted to receiving settings and/or commands from the internet-enabled device 602 as entered or retrieved by the user interface. For example, the user interface may in some embodiments be used to receive or retrieve stored settings, either stored by the current user in a previous operation, or received from other users in any suitable fashion, and to transfer the settings to the multichannel web server 612 to be used to control the load.

One or more communication paths may be used singly or in combination to connect the multichannel web server 612 to a multi-channel driver system 614, such as, but not limited to, a powerline connection 620, wired connection 622 and wireless connection 624 of any protocol. The multichannel web server 612 may be adapted to use one or more of these or other communication paths, and is not limited to the example illustrated with three communication paths. The multi-channel driver system 614 includes dimming drivers 616 of any suitable type, such as those disclosed herein or variations thereof. The multi-channel driver system 614 drives power 630, a current and/or voltage, or control signal, to one or more loads such as a white, red, green and blue LED lighting system 632.

In addition to dimming by adjusting, for example, a virtual GUI button or buttons, slider or sliders, knobs or knobs, etc. an/or with a physical potentiometer or set of potentiometers, encoders, decoders, etc., the present invention can also support all standards, ways, methods, approaches, techniques, etc. for interfacing, interacting with and supporting, for example, 0 to 10 V dimming with a suitable reference voltage that can be remotely set or set via an analog or digital input such as illustrated in U.S. Patent Application 61/652,033 filed on May 25, 2012, for a “Dimmable LED Driver”, and U.S. Patent Application 61/657,110 filed on Jun. 8, 2012 which are incorporated herein by reference for all purposes.

The present invention can support all standards and conventions for 0 to 10 V dimming or other dimming techniques. In addition the present invention can support, for example, overcurrent, overvoltage, short circuit, and over-temperature protection.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The dimmer for dimmable drivers and/or the dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, flyback and forward-converters. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention may be used with a linear regulator, a switching regulator, a linear power supply, a switching power supply, multiple linear and switching regulator and power supplies, hybrid linear and switching regulators, hybrids of these, combinations of these, etc.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the dimming of the present invention can be designed and implemented to drop, for example, by a factor of, for example, two. The output power, no matter where the circuit was originally in the dimming cycle, will, therefore, also drop/decrease. Values other than a factor of two (i.e., 50%) can also be used and are easily implemented in the present invention. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number and, essentially, any number of circuits, drivers, etc. including in parallel configurations. For example, more than one driver can be put together, grouped together with the present invention.

Some embodiments of a dimmable driver controlled by the interface disclosed herein may also provide thermal control or other types of control. For example, various embodiments may be adapted to provide overvoltage or overcurrent protection, short circuit protection for, for example, a dimming LED driver, or to override and cut the power to the dimming LED driver(s) based on, as an example, any arbitrary, fixed, programmed, inputted, selected, or set or set of, etc. external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, UARTS in general, etc.), wireless, powerline, powerline communications (PLC), etc. and can be implemented in any part of the circuit for the present invention. The present invention can be used with a buck, a buck-boost, a boost-buck and/or a boost, flyback, or forward-converter design, topology, implementation, etc.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

While illustrative embodiments have been described in detail herein, it is to be understood that the concepts disclosed herein may be otherwise variously embodied and employed. The configuration, arrangement and type of components in the various embodiments set forth herein are illustrative embodiments only and should not be viewed as limiting or as encompassing all possible variations that may be performed by one skilled in the art while remaining within the scope of the claimed invention.

What is claimed is:

1. A dimming driver system comprising:
a dimmable driver, comprising:
a power input;
a load output;
a power control switch operable to control a flow of current from the power input to the load output;
a variable pulse generator operable to control the power control switch; and
an energy storage device in series with the load output, the power control switch and the power input, operable to store energy from the power input when the power control switch is on and to release energy to the load output when the power control switch is off; and
a user interface operable to set a dimming level of the load output.

2. The dimming driver system of claim 1, wherein the load output comprises a multichannel output configured to independently control a dimming level of each of a plurality of output channels.

3. The dimming driver system of claim 1, wherein a power factor is increased by at least one time constant in the dimmable driver.

4. The dimming driver system of claim 1, wherein the dimmable driver is configured in a flyback mode with a power factor above about 0.98.

5. The dimming driver system of claim 1, wherein the energy storage device comprises a device selected from a group consisting of an inductor and a transformer.

6. The dimming driver system of claim 1, the dimmable driver further comprising a load current detector operable to detect a current to the load output and to control a pulse width from the variable pulse generator based at least in part on the current to the load output, wherein the load current detector has a time constant operable to substantially filter out a change in the current to the load output at a frequency of the variable pulse generator.

7. The dimming driver system of claim 1, wherein the user interface comprises a web page operable to accept settings for the dimming levels.

8. The dimming driver system of claim 7, wherein the web page comprises at least one dimming level input selected from a group consisting of a graphical input and a text input.

9. The dimming driver system of claim 1, further comprising a web server hosting the user interface.

10. The dimming driver system of claim 9, wherein the user interface is adapted to store settings for the dimming levels and to apply previously stored settings for the dimming levels.

11. The dimming driver system of claim 9, further comprising a routing device selected from a group consisting of a router and a switch, operable to route data from an internet enabled device to the web server.

12. The dimming driver system of claim 11, wherein data is communicated to the routing device by a connection type selected from a group consisting of wired and wireless.

13. The dimming driver system of claim 11, wherein data is communicated to the web server from the routing device by at least one connection type selected from a group consisting of wired, wireless and powerline connection.

14. The dimming driver system of claim 9, wherein the web server controls the dimmable driver via a connection selected from a group consisting of a wired connection and a wireless connection.

15. The dimming driver system of claim 9, wherein the web server controls the dimmable driver via multiple connections.

16. The dimming driver system of claim 1, wherein the dimmable driver comprises a universal dimmer, operable to limit the flow of current from the power input to the load output over each of a plurality of input voltage ranges at the power input.

17. A dimming driver, comprising:
a power input;
a load output;
a power control switch operable to control a flow of current from the power input;
a variable pulse generator operable to control the power control switch;
an inductor connected in series to the power input and the power control switch, load output, operable to store energy from the power input when the power control switch is on and to release energy to the load output when the power control switch is off;
a load current detector operable to detect a current to the load output and to control a pulse width from the variable pulse generator based at least in part on the current to the load output;
an input voltage range detector operable to reduce the pulse width from the variable pulse generator when a voltage at the power input exceeds a threshold; and
a dimming level input operable to control a pulse width from the variable pulse generator.

18. The dimming driver of claim 17, further comprising a web server operable to accept user input for the dimming level input.

19. The dimming driver of claim 18, further comprising a router operable to connect an internet-enabled user computing device to the web server.

20. The dimming driver of claim 18, wherein the web server is connected to the dimming level input by a plurality of connections.
